(19) United States
(12) Patent Application Publication
(10) Pub. No.: US 2024/0428540 A1
(43) Pub. Date: Dec. 26, 2024

(54) CONTROLLABLE 3D STYLE TRANSFER FOR RADIANCE FIELDS

(71) Applicants: DISNEY ENTERPRISES, INC., Burbank, CA (US); ETH Zürich (Eidgenössische Technische Hochschule Zürich), Zürich (CH)

(72) Inventors: Clara Maria FERNANDEZ LABRADOR, Zürich (CH); Christopher Richard SCHROERS, Uster (CH); Deheng ZHANG, Zürich (CH)

(21) Appl. No.: 18/751,038

(22) Filed: Jun. 21, 2024

Related U.S. Application Data
(60) Provisional application No. 63/510,053, filed on Jun. 23, 2023.

(51) Int. Cl. G06T 19/20; G06V 10/44

(52) U.S. Cl. CPC G06T 19/20; G06V 10/44; G06T 2219/2024

(57) ABSTRACT

The present invention sets forth a technique for performing style transfer. The technique includes converting a style sample into a first set of semantic features and a first set of visual features and determining a set of content samples corresponding to a plurality of views of a three-dimensional (3D) scene. The technique also includes, for each content sample included in the set of content samples, converting the content sample into an additional set of semantic features and an additional set of visual features and determining a set of matches between (i) the additional set of semantic features and the additional set of visual features and (ii) the first set of semantic features and the first set of visual features. The technique further includes generating a style transfer result, wherein the style transfer result comprises structural elements of the 3D scene and stylistic elements of the style sample.

### CROSS-REFERENCE TO RELATED APPLICATIONS

This application claims priority benefit of United States Provisional patent application titled “CONTROLLABLE 3D ARTISTIC STYLE TRANSFER FOR RADIANCE FIELDS,” Ser. No. 63/510,053, filed Jun. 23, 2023. The subject matter of this related application is hereby incorporated herein by reference.

### BACKGROUND

### Field of the Various Embodiments

Embodiments of the present disclosure relate generally to machine learning and image processing and, more specifically, to techniques for transferring styles in three-dimensional (3D) scenes.

### Description of the Related Art

Style transfer is a technique for generating stylized output by combining one or more structural elements included in one or more content samples with stylistic elements included in one or more style samples. Structural elements may include features such as objects, lines, edges, outlines, or surfaces. Stylistic elements may include one or more of colors, textures, patterns, or lighting characteristics included in the style samples. Style transfer is applicable to two-dimensional (2D) content samples, such as still images, or to 3D representations of the contents of a scene, such as neural radiance fields (NeRFs).

Existing techniques for performing style transfer in 3D representations of scenes are typically limited to transferring a style from a single style sample to the entirety of a content sample. Consequently, these techniques tend to lack fine-grained controllability, such as the ability to transfer a style to a specified element or object included in the content sample and/or transfer different styles to different regions within the content sample.

Other existing techniques may operate on 3D inputs, such as 3D point clouds or 3D mesh representations of content and/or style samples. One drawback of these techniques is that the quality of the style transfer is limited by the geometric quality/resolution of the 3D inputs. Further, these techniques require the generation of a detailed 3D representation for any 3D environment to be modified.

As the foregoing illustrates, what is needed in the art are more effective techniques for transferring styles in 3D scenes.

### SUMMARY

One embodiment of the present invention sets forth a technique for performing style transfer. The technique includes converting a style sample into a first set of semantic features and a first set of visual features, and determining a set of content samples corresponding to a plurality of views of a three-dimensional (3D) scene. For each content sample included in the set of content samples, the technique converts the content sample into an additional set of semantic features and an additional set of visual features and determines a set of matches between (i) the additional set of semantic features and the additional set of visual features and (ii) the first set of semantic features and the first set of visual features. Further, the technique generates a style transfer result that includes a representation of the 3D scene based on one or more losses associated with the sets of matches determined for the set of content samples, wherein the style transfer result comprises one or more structural elements of the 3D scene and one or more stylistic elements of the style sample.

One technical advantage of the disclosed techniques relative to the prior art is that the disclosed techniques allow for fine-grained controllability of style transfer to a 3D scene based on masks that identify specific regions of 2D renderings of the 3D scene. The disclosed techniques also allow for the transfer of different styles to different regions of a 3D scene. Further, the disclosed techniques can be used to perform semantically aware style transfer via masks and/or semantic features included in content and/or style samples. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments.

FIG. 2 is a high-level data flow diagram describing style transfer, according to some embodiments.

FIG. 3 is a flow diagram of method steps for performing style transfer, according to some embodiments.

FIG. 4 is a more detailed illustration of the preprocessing engine of FIG. 1, according to some embodiments.

FIG. 5 is a flow diagram of method steps for preprocessing content and style examples, according to some embodiments.

FIG. 6 is a more detailed illustration of the transfer engine of FIG. 1, according to some embodiments.

FIG. 7 is a flow diagram of method steps for performing style transfer, according to some embodiments.

FIG. 8 is a more detailed illustration of the transfer engine of FIG. 1, according to various other embodiments.

FIG. 9 is a flow diagram of method steps for performing style transfer, according to various other embodiments.

FIG. 10 is a more detailed illustration of the preprocessing engine of FIG. 1, according to various other embodiments.

FIG. 11 is a flow diagram of method steps for preprocessing content and style examples, according to various other embodiments.

FIG. 12 is a more detailed illustration of the transfer engine of FIG. 1, according to various other embodiments.

FIG. 13 is a flow diagram of method steps for performing style transfer, according to various other embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

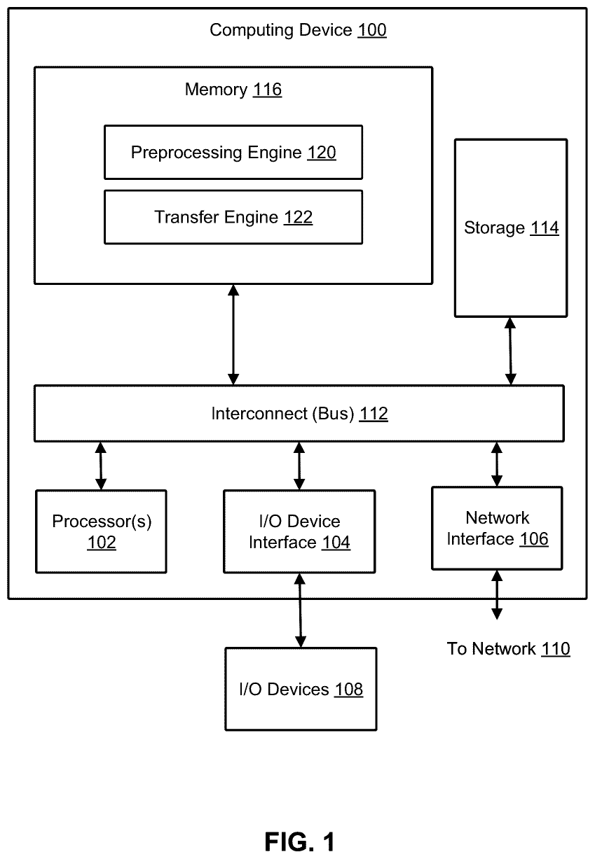

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a preprocessing engine 120 and a transfer engine 122 that reside in a memory 116.

It is noted that the computing device described herein is illustrative and that any other technically feasible configurations fall within the scope of the present disclosure. For example, multiple instances of preprocessing engine 120 or transfer engine 122 could execute on a set of nodes in a distributed and/or cloud computing system to implement the functionality of computing device 100. In another example, preprocessing engine 120 or transfer engine 122 could execute on various sets of hardware, types of devices, or environments to adapt preprocessing engine 120 or transfer engine 122 to different use cases or applications. In a third example, preprocessing engine 120 or transfer engine 122 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Preprocessing engine 120 or transfer engine 122 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including preprocessing engine 120 or transfer engine 122.

### Style Transfer Overview

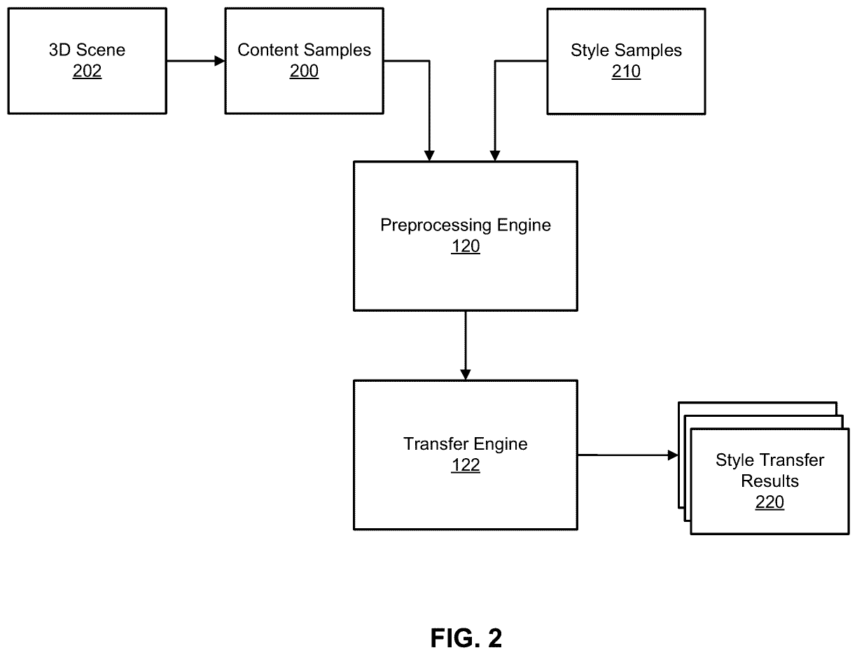

FIG. 2 is a high-level data flow diagram describing style transfer, according to some embodiments. In style transfer, the disclosed techniques modify a set of one or more content samples 200 based on a set of one or more style samples 210 to generate a set of one or more style transfer results 220. The disclosed techniques modify the one or more content samples 200 via preprocessing engine 120 and transfer engine 122.

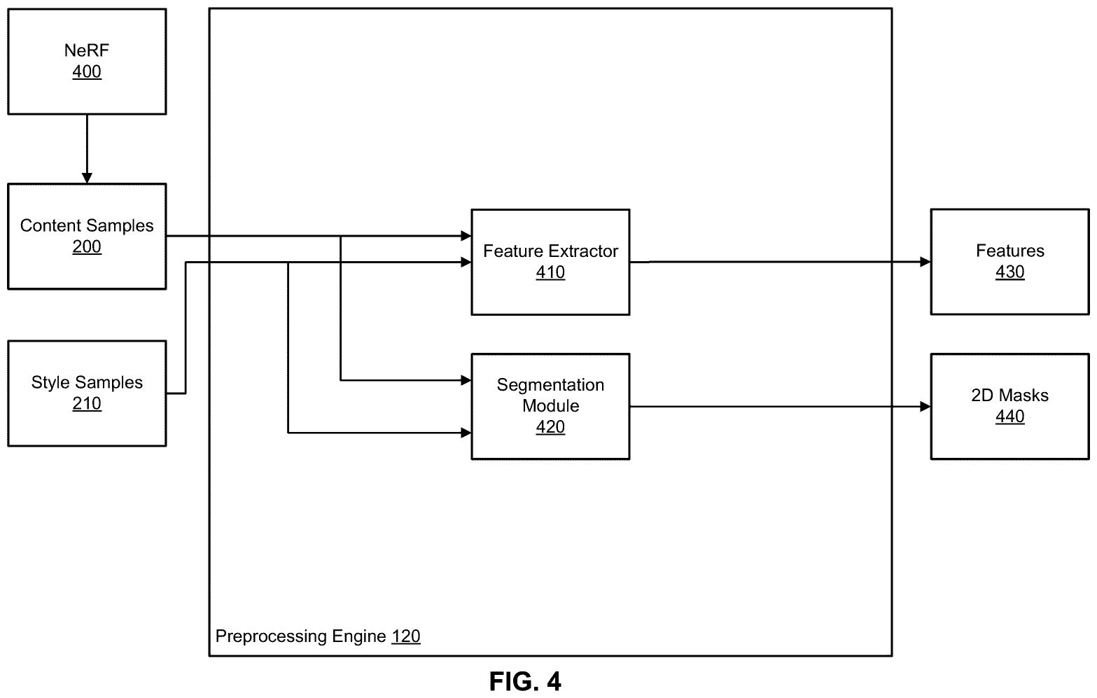

Content samples 200 include one or more two-dimensional (2D) depictions of a three-dimensional (3D) scene 202. Each of the one or more 2D depictions includes structural elements associated with one or more objects included in 3D scene 202, such as buildings, animals, or people. Structural elements may include flat or curved surfaces or edges associated with the one or more objects. In various embodiments, content samples 200 may include 2D renderings of 3D scene 202 encoded by, e.g., a neural radiance field (NeRF). Each 3D rendering included in content samples 200 may depict 3D scene 202 as viewed from a camera viewpoint, where the camera viewpoint includes a 3D position and orientation associated with a real or virtual camera. NeRFs are discussed in greater detail in the description of FIG. 4 below.

Style samples 210 include one or more 2D depictions of one or more stylistic elements. Stylistic elements may include colors, textures, patterns, or lighting characteristics. For example, a style sample 210 may include, without limitation, a depiction of a painting, a drawing, a sketch or a photograph.

Preprocessing engine 120 analyzes content samples 200 and style samples 210 to generate features associated with content samples 200 and/or style samples 210. In various embodiments, preprocessing engine 120 generates features associated with one or more sets of pixels included in each of content samples 200 and/or each of style samples 210. Each of the one or more features may be based on visual features included in one of content samples 200 or one of style samples 210. Additionally or alternatively, each of the one or more features may be based on semantic features included in one of content samples 200 or one of style samples 210.

Preprocessing engine 120 further analyzes content samples 200 and style samples 210 to generate 2D masks associated with one or more of content samples 200 and/or style samples 210. A 2D mask includes a contiguous or non-contiguous set of pixels representing one or more regions within a content sample included in content samples 200 or a style sample included in style samples 210. For example, a 2D mask may include a set of pixels representing an object included in one of content samples 200, while a different 2D mask may include a set of pixels representing a background included in the one of content samples 200.

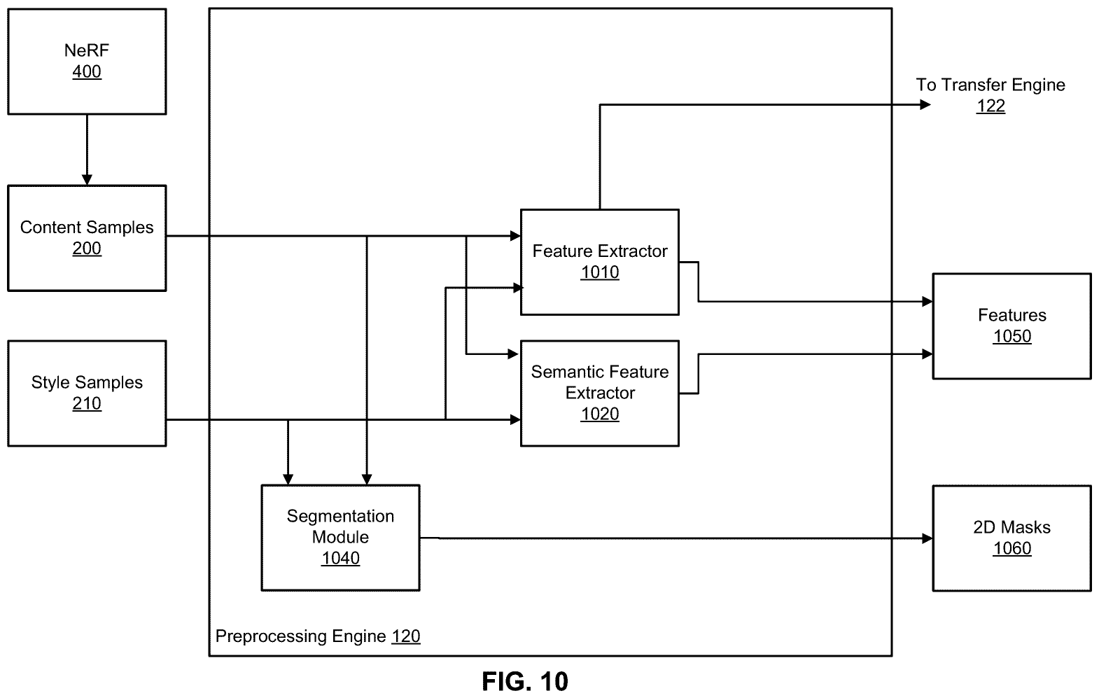

In various embodiments, preprocessing engine 120 assigns a label to one or more generated 2D masks. A label may include a semantic designation associated with a region represented by a 2D mask, such as “flower” or “horse.” A label may also designate a background region in a content sample to which a style will not be transferred. In various embodiments, preprocessing engine 120 may assign a label to a 2D mask based on user input, visual features associated with a region represented by the 2D mask, and/or semantic features associated with a region represented by the 2D mask. Preprocessing engine 120 is discussed in greater detail in the descriptions of FIGS. 4 and 10 below.

Transfer engine 122 generates one or more style transfer results 220 based on features and/or 2D masks generated by preprocessing engine 120. Style transfer results 220 may include an updated NeRF or other representation of 3D scene 202 that includes stylistic elements of one or more style samples 210 and structural elements of one or more content samples 200. For example, style transfer results 220 may include a representation of 3D scene 202 in which an object included in 3D scene 202 has been modified based on stylistic elements included in one of style samples 210. Transfer engine 122 performs nearest neighbor feature matching on the features, associating structural features included in a content sample 200 with stylistic features included in a style sample 210. Transfer engine 122 associates a feature included in a content sample 200 with a feature included in a style sample 210 based on, e.g., a calculated distance between the features.

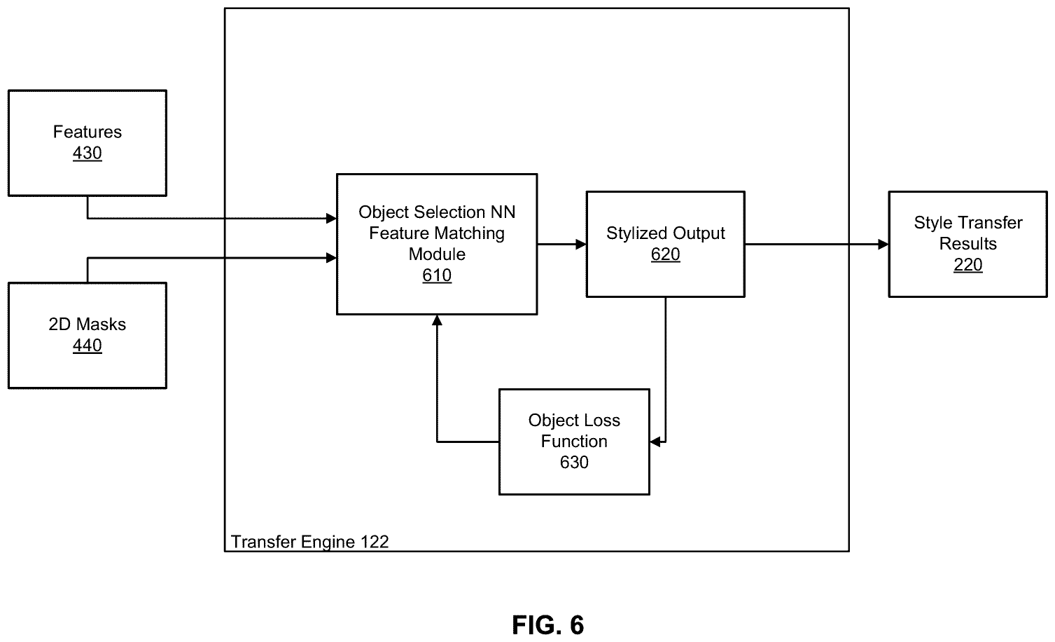

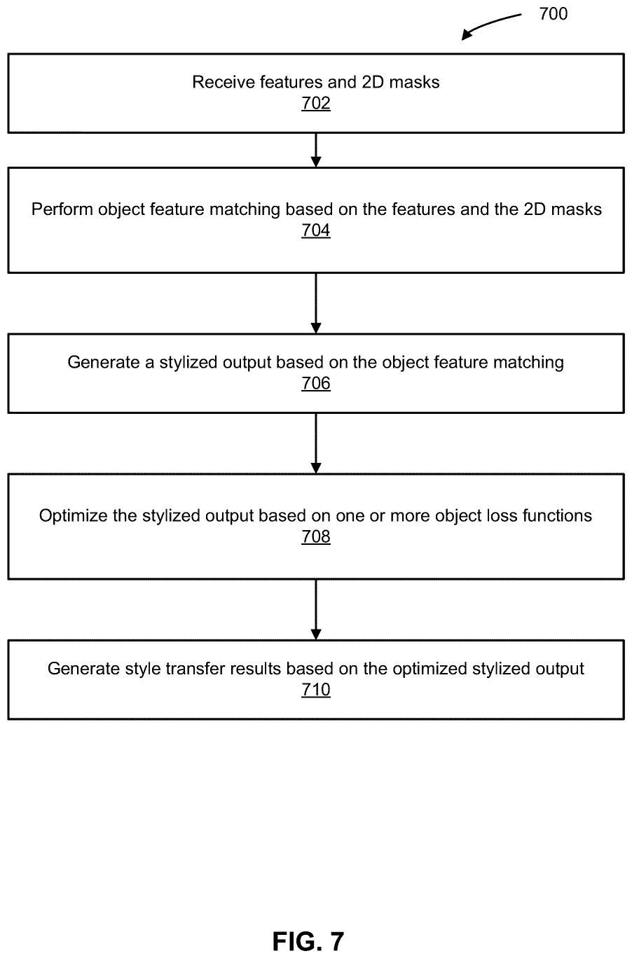

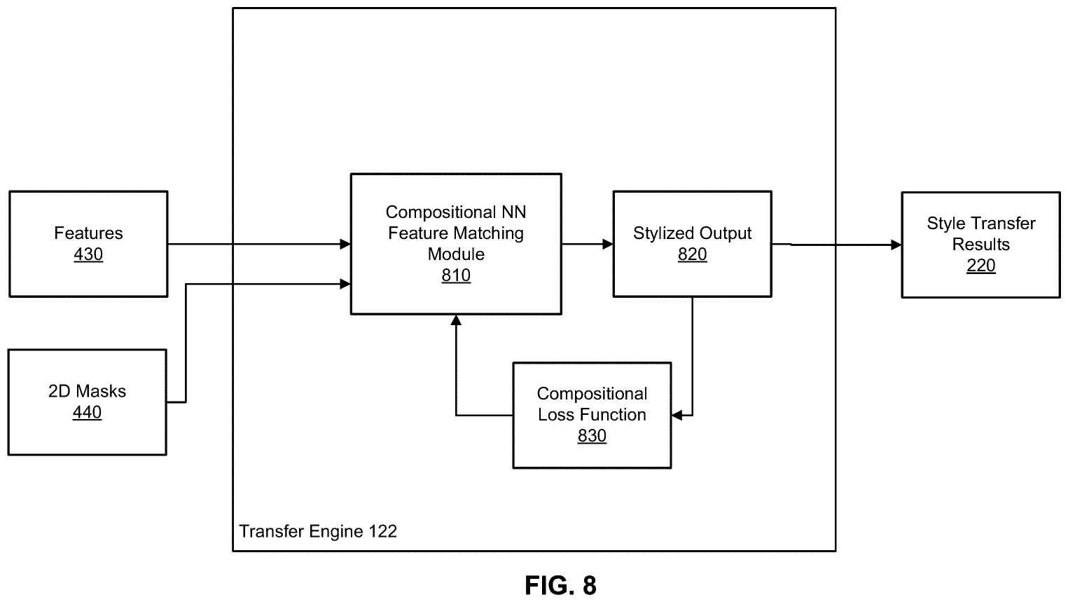

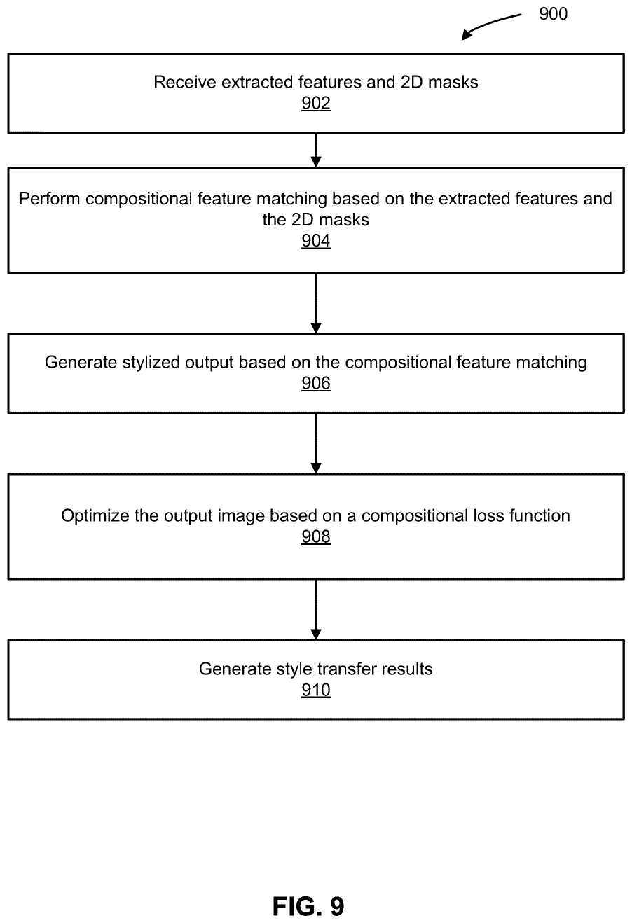

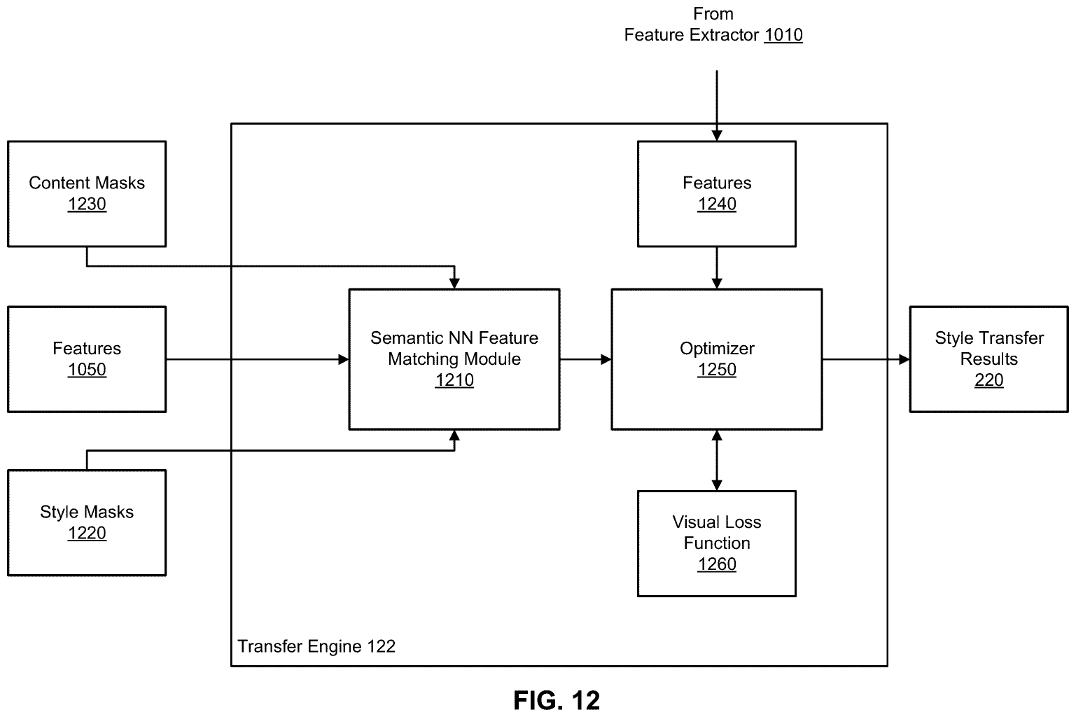

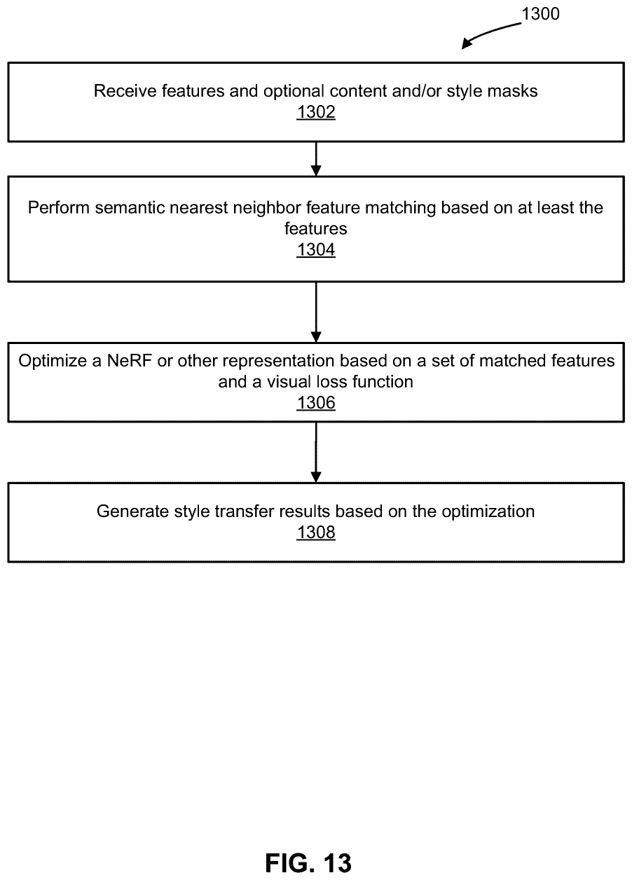

In various embodiments, transfer engine 122 may perform object selection style transfer to transfer stylistic elements included in one of style samples 210 to a region depicted in one of content samples 200, while leaving other regions depicted in the one of content samples 200 unmodified. Object selection style transfer is discussed in greater detail in the descriptions of FIGS. 6 and 7 below. In other embodiments, transfer engine 122 may perform compositional style transfer to transfer a different stylistic element to each of multiple regions depicted in one of content samples 200. Compositional style transfer is discussed in greater detail in the descriptions of FIGS. 8 and 9 below. In yet other embodiments, transfer engine 122 may perform semantically aware style transfer to transfer stylistic elements from one or more regions depicted in one or more of style samples 210 to corresponding regions depicted in one or more of content samples 200. In these embodiments, transfer engine 122 may transfer the stylistic elements based on similarities between semantic characteristics associated with regions included in the one or more of content samples 200 and the one or more of style samples 210. Semantically aware style transfer is discussed in greater detail in the descriptions of FIGS. 12 and 13 below.

Transfer engine 122 generates stylized output based on the features and/or 2D masks. Stylized output may include one or more 2D renderings generated by a neural radiance field (NeRF) or another representation of 3D scene 202. Transfer engine 122 matches features included in one or more of content samples 200 to features included in the one or more of style samples 210 and decodes the features to generate the stylized output. Transfer engine 122 iteratively modifies the NeRF or other 3D representation of 3D scene 202 to optimize the stylized output based on one or more loss functions. Transfer engine 122 is discussed in greater detail in the descriptions of FIGS. 6, 8, and 12 below.

Style transfer results 220, as discussed above, include an updated NeRF or other representation of 3D scene 202 that includes stylistic elements of one or more style samples 210 and structural elements of one or more content samples 200. For example, a content sample included in content samples 200 may depict a flower included in 3D scene 202, and a style sample included in style samples 210 may depict a painting executed in the French impressionist style. Based on the content sample and style sample, transfer engine 122 may generate style transfer results 220 that include a representation of 3D scene 202 in which the flower is modified to include one or more stylistic elements included in the painting, such as colors, textures, patterns, and/or lighting characteristics.

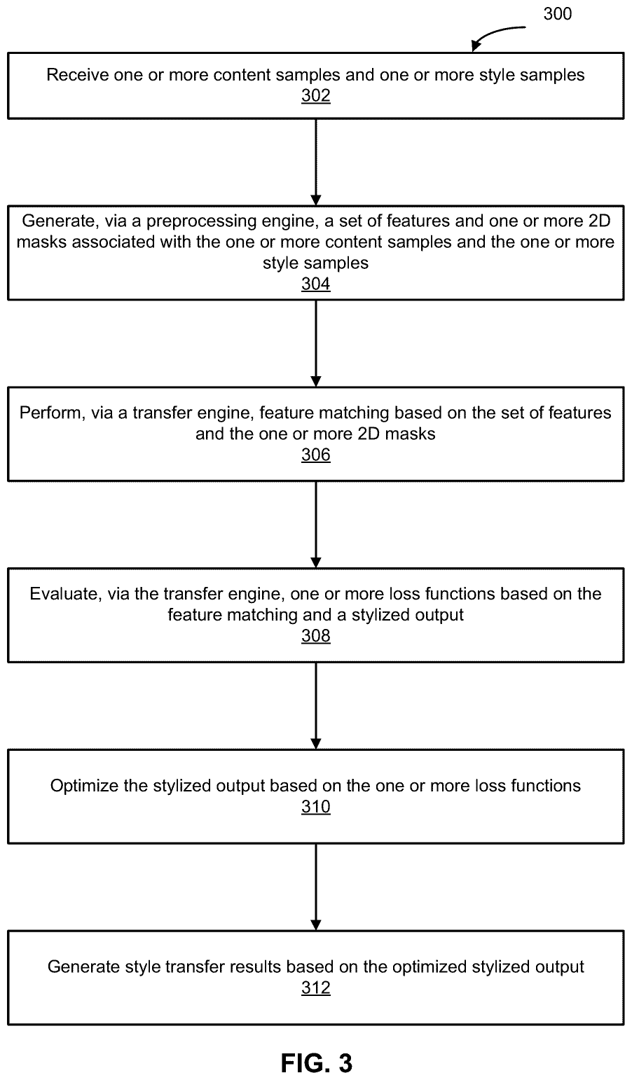

FIG. 3 is a flow diagram of method steps for performing style transfer, according to some embodiments. Although the method steps are described in conjunction with the systems of FIGS. 1-2, persons skilled in the art will understand that any system configured to perform the method steps in any order falls within the scope of the present disclosure.

As shown, in step 302 of method 300, the disclosed techniques receive one or more content samples 200 and one or more style samples 210. In various embodiments, content samples 200 may include one or more 2D renderings of 3D scene 202 as encoded by, e.g., a neural radiance field (NeRF). Style samples 210 may include one or more 2D depictions, where each 2D depiction includes one or more stylistic elements. Stylistic elements may include colors, textures, patterns, or lighting characteristics. For example, a style sample 210 may include, without limitation, a depiction of a painting, a drawing, a sketch or a photograph.

In step 304, preprocessing engine 120 generates a set of features associated with one or more content samples 200. Preprocessing engine 120 also generates a set of features associated with one or more style samples 210. In various embodiments, preprocessing engine 120 generates the features based on visual and/or semantic elements included in the one or more content samples 200 and/or one or more style samples 210. Preprocessing engine 120 further generates one or more 2D masks, where each 2D mask represents a set of pixels included in one of content samples 200 or one of style samples 210. In various embodiments, preprocessing engine 120 may assign a label to one or more of the generated 2D masks, where the label may include a semantic description of the set of pixels, such as “flower” or “horse.” Preprocessing engine 120 may also assign a label to a generated 2D mask indicating that a set of pixels in a content sample 200 associated with the 2D mask will not be modified via style transfer.

In step 306, transfer engine 122 performs feature matching based on the generated sets of features and/or the generated 2D masks. In various embodiments, transfer engine 122 performs nearest neighbor feature matching to match features associated with one of content samples 200 to features associated with one of style samples 210, based on distances calculated between the features. In various embodiments, transfer engine 122 may perform feature matching based on pixel locations associated with the generated 2D masks, as discussed in further detail below.

In step 308, transfer engine 122 evaluates one or more loss functions based on the feature matching and a stylized output. The stylized output may include one or more 2D renderings generated based on a NeRF or other representation of 3D scene 202. In various embodiments, the one or more loss functions may be based on features extracted from one of content samples 200, features extracted from one of style samples 210, and/or generated 2D masks.

In step 310, transfer engine 122 optimizes the stylized output based on the one or more loss functions. Transfer engine 122 modifies one or more parameters included in a NeRF or other representation of 3D scene 202 based on the one or more loss functions and generates updated content samples 200 based on the modified NeRF or other representation. In various embodiments, transfer engine 122 may repeat steps 308 and 310 to iteratively optimize the stylized output until values associated with the one or more loss functions are below a predetermined threshold. In other embodiments, transfer engine 122 may optimize the stylized output for a predetermined number of iterations, or for a predetermined period of time.

In step 312, transfer engine 122 generates style transfer results 220. Style transfer results 220 include a NeRF or other representation of 3D scene 202, as modified via the optimization steps described above. Any or all of steps 302, 304, 306, 308, 310, 312, and 314 may be repeated to generate additional style transfer results 220 associated with additional content samples included in content samples 200. The generation of style transfer results via optimization is discussed in greater detail in the descriptions of FIGS. 6, 8, and 12 below.

### Data Preprocessing and Object Selection Nearest Neighbor Feature Matching

FIG. 4 is a more detailed illustration of preprocessing engine 120 of FIG. 1, according to some embodiments. In some embodiments, preprocessing engine 120 receives one or more content samples 200 and one or more style samples 210, and generates features 430 and 2D masks 440. As discussed above, content samples 200 may include 2D renderings of 3D scene 202 as encoded by, e.g., a neural radiance field (NeRF) 400. Preprocessing engine 120 includes, without limitation, one or more feature extractors 410 and a segmentation module 420.

NeRF 400 includes an encoded representation of 3D scene 202. In various embodiments, NeRF 400 is trained on multiple 2D views of 3D scene 202 captured by a real or virtual camera having a specified 3D location and 2D orientation. NeRF 400 includes a mapping f: [symbol] , which takes a 3D position x within 3D scene 202 and a viewing direction d as input and outputs density σ and radiance c:

$$σ , c = RADIANCEFIELD ( x , d ) \qquad ( 1 )$$

NeRF 400 may be used to render content samples 200 representing novel 2D views of encoded 3D scene 202 for a given virtual camera position and orientation by calculating and summing radiance values for multiple points xi along a ray r originating at the virtual camera position and terminating at a specified location within 3D scene 202:

$$c ( r ) = {\sum }_{i = 1}^{N} {w}_{i} {c}_{i} , {w}_{i} = {T}_{i} ( 1 - exp ( - {σ}_{i} {δ}_{i} ) ) , \qquad ( 2 )$$

$$where {T}_{i} = exp ( - {\sum }_{j = 1}^{i - 1} {σ}_{j} {δ}_{j} ) \qquad ( 3 )$$

and δᵢ represents a differential length along the ray r.

In various embodiments, NeRF 400 is implemented via a Plenoxels radiance field function that represents radiance values for 3D locations within 3D scene 202 as spherical harmonics functions in a 3D grid of volume elements (voxels). Various other embodiments may include different or additional neural radiance field functions or representations. NeRF 400 is pre-trained on a data set including multi-view ground truth content images associated with a 3D scene. After pre-training, the density field function σ of NeRF 400 is fixed, and further training is limited to adjusting the radiance field function c of NeRF 400. During a style transfer task, NeRF 400 is fine-tuned by defining an averaged pixel-wise loss function on a rendered 2D view:

$$L = \frac{1}{N} {\sum }_{x , y} ( {l}_{nnfm} ( {F}_{r} ( x , y ) , {F}_{s} ) + λ \cdot {l}_{2} ( {F}_{r} ( x , y ) , {F}_{c} ( x , y ) ) ) + {λ}_{t v} \cdot {l}_{tv} , \qquad ( 4 )$$

Where N is the number of pixels and Fᵣ, Fₛ, and F_{c} are features extracted from 2D renderings generated using NeRF 400, 2D style samples 210, and ground-truth training content used to generate NeRF 400, respectively. For each of Fᵣ, Fₛ, and F_{c}, F(x, y) represents a feature or set of features at pixel location (x, y). l_{nnfm} represents a nearest neighbor feature matching loss between a rendering and an associated style sample, l₂ represents a mean-squared error (MSE), and lₜᵥ represents a total variation loss. λ and λₜᵥ represent adjustable content loss factors associated with the l₂ and lₜᵥ losses, respectively.

Each of content samples 200 may include a 2D rendering of encoded 3D scene 202 generated via application of Equations (2) and (3) above to NeRF 400. Each of content samples 200 may represent a rendered 2D view of 3D scene 202 based on a given virtual camera position and orientation. Style samples 210 include 2D representations that include one or more stylistic elements, such as colors, patterns, textures, and/or lighting characteristics. Examples of style samples 210 include paintings, drawings, sketches, or photographs. As discussed below in the descriptions of FIGS. 6, 8, and 12, the disclosed techniques modify NeRF 400 or another representation of 3D scene 202 based on content samples 200 and one or more stylistic elements included in style samples 210.

Feature extractor 410 generates features associated with each of content samples 200 and each of style samples 210. In various embodiments, feature extractor 410 may include a Visual Geometry Group (VGG) feature extractor, a Convolutional Neural Network (CNN) feature extractor, and/or other machine learning models suitable for extracting features from a visual representation.

Segmentation module 420 generates one or more 2D masks 440 associated with content samples 200 and style samples 210. Segmentation module 420 may include a semantically aware segmentation technique, such as LSeg, and/or any other segmentation technique suitable for generating 2D masks associated with 2D representations. In various embodiments, segmentation module 420 may generate masks based on visual characteristics of a 2D representation, such as lines, surfaces, textures, or colors included in the 2D representation. Alternatively or additionally, segmentation module 420 may generate masks based on semantic features included in a 2D representation. For example, segmentation module 420 may identify a specific object included in the 2D representation as a horse and generate a 2D mask 440 associated with the horse. In yet other embodiments, segmentation module 420 may additionally or alternatively generate 2D masks 440 based on user input. For example, a user may manually draw or otherwise annotate one or more pixels and/or a region included in one of content samples 200 and/or style samples 210, and segmentation module 420 may generate a 2D mask 440 based on the annotation.

Each of 2D masks 440 is associated with a set of pixels included in one of content samples 200 or one of style samples 210. A set of pixels may be contiguous or non-contiguous. Each of 2D masks 440 may include an assigned label m out of M labels, such that each pixel included in one of 2D masks 440 is associated with the label m assigned to the one of 2D masks 440. In various embodiments, a label may include a semantic description of a set of pixels, such as “flower” or “horse.” A label may also designate a region of a content sample to which a style will not be transferred, leaving the region of the content sample unmodified.

For a single view included in content samples 200, segmentation module 420 may be unable to accurately generate a 2D mask associated with an occluded object included in the single view. By analyzing multiple views of 3D scene 202 included in content samples 200, segmentation module 420 is operable to accurately associate 2D masks 440 with specific objects or regions included in content samples 200.

Features 430 include features associated with content samples 200 and/or style samples 210. In various embodiments, features 430 may include representations of visual, semantic, and/or other types of information included in content samples 200 and/or style samples 210. In various embodiments, features 430 may include a feature vector associated with each pixel included in one of content samples 200 or one of style samples 210. In other embodiments, features 430 may include 2D or 3D feature maps, and a feature included in features 430 may represent one or more regions included in one of content samples 200 and/or one of style samples 210, entire images included in content samples 200 and/or style samples 210, or a set of multiple images included in content samples 200 and/or style samples 210.

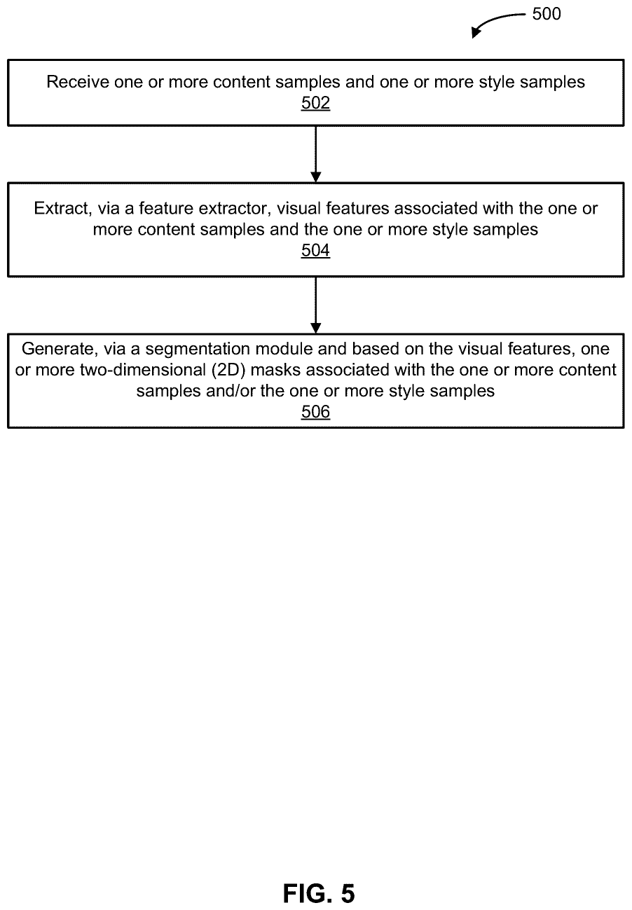

FIG. 5 is a flow diagram of method steps for preprocessing content and style examples, according to some embodiments. Although the method steps are described in conjunction with the systems of FIGS. 1-2 and 4, persons skilled in the art will understand that any system configured to perform the method steps in any order falls within the scope of the present disclosure.

As shown, in step 502 of method 500, preprocessing engine 120 receives one or more content samples 200 and one or more style samples 210. Content samples 200 may include one or more 2D renderings of 3D scene 202 generated based on neural radiance field (NeRF) 400. Style samples 210 may include one or more stylistic elements, such as (but not limited to) colors, textures, patterns, or lighting characteristics.

In step 504, preprocessing engine 122 extracts, via feature extractor 410, visual features associated with one or more of content samples 200 and visual features associated with one or more of style samples 210. In various embodiments, feature extractor 410 may include one or more machine learning models, such as a Visual Geometry Group (VGG) extractor or a Convolutional Neural Network (CNN).

In step 506, preprocessing engine 122 generates, via segmentation module 420, one or more 2D masks 440 associated with one or more of content samples 200 and one or more 2D masks 440 associated with one or more of style samples 210. In various embodiments, segmentation module 420 may generate one or more of 2D masks 440 based on visual characteristics included in one or more of content samples 200 or one or more of style samples 210. Segmentation module 420 may also generate one or more of 2D masks 440 based on semantic features included in one of content samples 200 or one of style samples 210. In various other embodiments, segmentation module 420 may also generate one or more of 2D masks 440 based on user input, such as a manual user annotation of a pixel or region included in one of content samples 200 or one of style samples 210.

FIG. 6 is a more detailed illustration of transfer engine 122 of FIG. 1, according to some embodiments. FIG. 6 illustrates how transfer engine 122 performs object selection nearest neighbor style transfer. Transfer engine 122 receives features 430 and 2D masks 440. Transfer engine 122 performs object selection nearest neighbor feature matching to transfer style elements from a style sample to a representation of 3D scene 202, such as NeRF 400, based on features 430 and 2D masks 440. Transfer engine 122 generates style transfer results 220 based on the feature matching. Transfer engine 122 includes, without limitation, object selection NN feature matching module 610, stylized output 620, and object loss function 630.

As described above in reference to FIG. 4, features 430 may include pixel-wise features associated with one or more of content samples 200 and one or more of style samples 210. 2D masks 440 include one or more masks representing regions of the one or more of content samples 200 to which a style is to be transferred from one or more of style samples 210, and regions of the one or more of content samples 200 which are to remain unmodified. In various embodiments, a 2D mask included in 2D masks 440 may include an associated binary label m=0 if the associated region is to remain unmodified, and a binary label m=1 if the region is to be modified with a transferred style.

Transfer engine 122 includes a controllable object loss function 630:

$$L = ( \frac{1}{N} {\sum }_{x , y} {\sum }_{m} [ {M}_{r} ( x , y ) = m ] {L}^{m} ( x , y ) ) + {λ}_{t v} \cdot {l}_{t v} \qquad ( 5 )$$

where N is the number of pixels, and L^{m} is a pixel-wise loss function defined for corresponding label m. The term [symbol] [condition] returns a value of 1 if the condition is met and returns a value of 0 if the condition is not met. The lₜᵥ term represents a total variance loss, and the λₜᵥ is an adjustable total variance content loss factor.

Each of content samples 200 represents a volume rendering of 3D scene 202 encoded by a NeRF, viewed from a particular virtual camera viewpoint. In volumetric rendering, the final gradient ∇_{c}_{_{A}}L for the radiance of a point A included in the 3D scene is given by:

$${∇}_{{c}_{A}} L = {\sum }_{v} {w}_{A}^{v} ∇ {L}^{{m}_{v}} \qquad ( 6 )$$

where w_{A}^{v} represents the contribution of point A during volumetric rendering for view v, mᵥ is the label associated with point A, and ∇L^{m}^{ᵥ} represents the gradient of the corresponding loss with respect to the rendered pixel value. During segmentation, point A in 3D scene 202 will be assigned an incorrect label if point A is occluded, and point A will be assigned the correct label if point A is visible. In equation (6), the contribution of point A during optimization will be higher for views in which point A is visible, and lower for views in which point A is occluded. Thus, the contributions w_{A}^{v} associated with views where point A is visible will dominate the final gradient value ∇_{c}_{_{A}}L for the radiance of point A, enabling transfer engine 122 to correctly optimize NeRF 400 or another representation of 3D scene 202 based on 2D masks 440.

Object selection nearest neighbor (NN) feature matching module 610 calculates nearest matching features included in features 430 and associated with one of multiple content samples 200 and one of style samples 210. For example, given features 430 associated with a region of a content sample having a binary label m=1, object selection NN feature matching module 610 may, for a subset of features 430 associated with each pixel included in the region, determine a nearest matching subset of features 430 associated with one of style samples 210 based on, e.g., a cosine vector distance. Object selection NN feature matching module 610 records the nearest matching subset of features 430 and the associated pixel location. For a region of a content sample having a binary label m=0, object selection NN feature matching module 610 may omit the determination of nearest matching features 430 and may instead record the subset of features 430 associated with each pixel in the region and the associated pixel location. Transfer engine 122 generates stylized output 620 based on the recorded style or content features associated with each pixel location.

Stylized output 620 includes one or more rendered views of 3D scene 202 that are iteratively updated based on features 430 from style samples 210 that have been matched to features 430 from content samples 200 by object selection NN feature matching module 610. For each pixel location (x, y) in stylized output 620, the associated features 430 include either a subset of content features 430 originally extracted from one of content samples 200 or a subset of style features 430 originally extracted from one of style samples 210 and matched to the subset of content features 430 extracted from the content sample(s) by object selection NN feature matching module 610. Collectively, the features included in stylized output 620 represent a modified scene, where one or more objects or other structural elements included in one or more of content samples 200 are modified with stylistic elements included in one of style samples 210.

In various embodiments, different types of losses L^{m}(x, y) may be incorporated into object loss function 630 according to 2D masks 440:

$${L}^{m} ( x , y ) = \{ \begin{matrix}{l}_{2} & m = 0 \\ {l}_{nnfm} + λ \cdot {l}_{2} & m = 1\end{matrix} \qquad ( 7 )$$

In Equation (7), l₂ represents an L2 loss, such as a mean-squared error (MSE) loss calculated for pixel locations included in stylized output 620 that correspond with a masked region included in one of content samples 200 that has an associated binary label m=0. As discussed above, the binary mask label m=0 may indicate that pixel locations within the masked region of the content are to remain unmodified.

For regions included in one of content samples 200 that include a binary label m=1, the calculated loss l_{nnfm}+λ·l₂ includes the l₂ loss described above multiplied by an adjustable content loss factor λ, as well as a nearest neighbor feature matching loss l_{nnfm}, where

$${l}_{nnfm} ( {F}_{r} ( x , y ) , {F}_{s} ) = {min}_{{x}^{′} , {y}^{′}} D ( {F}_{r} ( x , y ) , {F}_{s} ( {x}^{′} , {y}^{′} ) ) , \qquad ( 8 )$$

$$and$$

$$D ( {v}_{1} , {v}_{2} ) = 1 - \frac{{v}_{1}^{T} {v}_{2}}{\sqrt{{v}_{1}^{T} {v}_{1} {v}_{2}^{T} {v}_{2}}} \qquad ( 9 )$$

Equation (8) calculates a minimum value of a vector distance D between a feature vector Fᵣ extracted from a given pixel location (x, y) in stylized output 620 and feature vectors Fₛ extracted from pixel locations (x′, y′) in one of style samples 210. Equation (9) describes the vector distance D between a pair of vectors v₁ and v₂.

In various embodiments, transfer engine 122 may optimize stylized output 620 by iteratively performing nearest neighbor feature matching via object selection NN feature matching module 610 for a predetermined number of iterations and/or for a predetermined time. Alternatively, transfer engine 122 may iteratively optimize stylized output 620 until the object loss function 630 is minimized, or until the object loss function 630 is below a predetermined threshold.

Transfer engine 122 generates style transfer results 220 based on optimized stylized output 620. Style transfer results may include an updated NeRF or another representation of 3D scene 202 that includes stylistic elements of the style samples 210 and structural elements of the content samples 200. For example, a content sample included in content samples 200 may depict a flower, and a style sample included in style samples 210 may depict a painting executed in the French impressionist style. Based on the content sample and style sample, transfer engine 122 may generate style transfer results 220 that include a structural representation of the flower included in the content sample modified to include one or more stylistic elements included in the style sample, such as colors, textures, patterns, and/or lighting characteristics. In various embodiments, the style transfer techniques are informed and guided by 2D masks 440. For example, one or more of 2D masks 440 may designate one or more regions included in content samples 200 to which an artistic style is to be transferred. One or more of 2D masks 440 may designate one or more regions included in content samples 200 to which no artistic style is to be transferred. One or more of 2D masks 440 may also designate one or more regions included in style samples 210 that are to be used as a source of an artistic style to be transferred to a representation of 3D scene 202, such as a NeRF. Style transfer results 220 may be used to render novel 2D views of 3D scene 202 that include structural elements of 3D scene 202 and stylistic elements of one or more style samples 210 applied to specific regions of the 3D scene as defined by 2D masks 440.

FIG. 7 is a flow diagram of method steps for performing style transfer, according to some embodiments. Although the method steps are described in conjunction with the systems of FIGS. 1-2, 4, and 6, persons skilled in the art will understand that any system configured to perform the method steps in any order falls within the scope of the present disclosure.

As shown, in step 702 of method 700, transfer engine 122 receives features 430 and 2D masks 440. Features 430 include representations of visual, semantic, and/or other attributes from one or more content samples 200 and one or more style samples 210. 2D masks 440 denote regions included in the one or more of content samples 200. For example, each of the masks included in 2D masks 440 may include a binary mask label m indicating whether the region is to be modified via style transfer (m=1) or whether the region is not to be modified (m=0).

In step 704, transfer engine 122 performs object selection nearest neighbor (NN) feature matching via object selection NN feature matching module 610. In some embodiments, for each region included in one of content samples 200 and having an associated binary mask label m=1, object selection NN feature matching module 610 performs pixel-wise nearest neighbor feature matching. For each feature included in the region, object selection NN feature matching module 610 determines a nearest feature associated with one of style samples 210 based on, e.g., a cosine vector distance. For a region having an associated binary mask label m=0, transfer engine 122 may omit the determination of a nearest feature associated with the one of style samples 210.

In step 706, transfer engine 122 generates stylized output 620 based on the nearest neighbor feature matching. Stylized output 620 includes renderings generated using a NeRF or another representation of 3D scene 202.

In step 708, transfer engine 122 optimizes stylized output 620 based on object loss function 630. In various embodiments, transfer engine 122 evaluates object loss function 630 to calculate a different object loss for regions having a binary mask value m=0 and regions having a binary mask value m=1. Transfer engine 122 iteratively optimizes stylized output 620 by updating parameters of NeRF 400 or another representation of 3D scene 202 based on losses calculated using object loss function 630, which is computed using distances between style features matched to content features associated with the m=1 label in step 704 and features extracted from stylized output 620.

In step 710, transfer engine 122 generates style transfer results 220 based on stylized output 620. Style transfer results 220 include a modified NeRF or other representation of 3D scene 202. The modified NeRF or other representation includes structural elements of one or more of content samples 200 and stylistic elements of one or more of style samples 210. The modified NeRF or other representation may be used to render novel views of 3D scene 202, where structural elements included in 3D scene 202 have been modified based on stylistic elements included in one or more of style samples 210.

### Compositional Nearest Neighbor Feature Matching

FIG. 8 is a more detailed illustration of transfer engine 122 of FIG. 1, according to various other embodiments. FIG. 8 illustrates how transfer engine 122 performs compositional style transfer. Transfer engine 122 receives features 430 and 2D masks 440. Transfer engine 122 performs compositional nearest neighbor feature matching to transfer style elements from multiple style samples 210 to multiple regions included in a content sample 200 based on features 430 and 2D masks 440. Transfer engine 122 generates style transfer results 220 based on the feature matching. Transfer engine 122 includes, without limitation, compositional NN feature matching module 810, stylized output 820, and compositional loss function 830.

As described above in reference to FIG. 4, features 430 are generated from content samples 200 and style samples 210. 2D masks 440 include one or more masks representing regions included in one or more of content samples 200 to which styles are to be transferred from style samples 210. In various embodiments, each 2D mask included in 2D masks 440 includes an associated label m=[0, 1, 2, . . . , M]. Each of style samples 210 may also include an associated label m. Transfer engine 122 transfers stylistic elements from a style sample included in style samples 210 having a label m to one or more regions included in one or more of content samples 200 associated with one or more 2D masks having the same label m.

Compositional nearest neighbor (NN) feature matching module 810 calculates nearest matching features included in features 430 and associated with one of multiple content styles 210 and style samples 210. For example, given features associated with a region of a content sample having a label m, compositional NN feature matching module 810 may, for each feature included in the region, determine a nearest matching feature or subset of features included in features 430 and associated with a style sample included in style samples 210 having the same label m. The nearest neighbor feature matching may be based on, e.g., a cosine vector distance. Compositional NN feature matching module 810 records the nearest matching feature or subset of features and the associated feature location. For a region of a content sample without a label or with a label indicating that the region is to remain unmodified, compositional NN feature matching module 810 may omit the determination of a nearest matching feature, and may instead record the content sample feature and the associated feature location. Transfer engine 122 generates stylized output 820 based on the recorded style or content features associated with each pixel location.

Stylized output 820 may include one or more 2D renderings generated by a neural radiance field (NeRF) or another representation of 3D scene 202. Transfer engine 122 replaces features included in one or more of content samples 200 with features included in the one or more of style samples 210 and decodes the features to generate stylized output 820. Transfer engine 122 iteratively modifies the NeRF or other 3D representation of 3D scene 202 to optimize stylized output 820 based on one or more loss functions. For each pixel location (x, y) in stylized output 820, the associated feature includes either a content feature originally extracted from the one of content samples 200 or a style feature originally extracted from one of style samples 210. Collectively, the features included in stylized output 820 represent a modified scene, where each of one or more objects or other structural elements included in the one of content samples 200 are modified with stylistic elements included in one of style samples 210.

Transfer engine 122 calculates a compositional loss function 830 based on stylized output 820. In various embodiments, compositional loss function 830 determines a different pixel-wise loss L^{m}(x, y) for each of the labeled 2D masks associated with the one of content samples 200 and the labels included in each of style samples 210:

$${L}^{m} ( x , y ) = {l}_{nnfm} ( {F}_{o} ( x , y ) , {F}_{s}^{m} ) + λ \cdot {l}_{2} ( {F}_{o} ( x , y ) , {F}_{c} ( x , y ) ) \qquad ( 10 )$$

In Equation (10), 12 represents an L2 loss, such as a mean-squared error (MSE) loss calculated for pixel locations included in stylized output 820 that correspond with one or more regions included in one of content samples 200 where no style is to be applied. λ represents an adjustable content factor. In various embodiments, λ may equal 0.001 or 0.005. Fₒ(x, y) represents features associated with pixel location (x, y) included in stylized output 820, Fₛ^{m} represents features associated with one of style samples 210 having a label m, and F(x, y) represents a feature associated with pixel location (x, y) included in one of content samples 200. For regions included in one of content samples 200 that include a label m, the l_{nnfm}(Fₒ(x, y), Fₛ^{m}) term in Equation (10) is defined by Equations (8) and (9) above.

In various embodiments, transfer engine 122 may optimize stylized output 820 by iteratively performing nearest neighbor feature matching via compositional NN feature matching module 810 for a predetermined number of iterations or for a predetermined time. Alternatively, transfer engine 122 may iteratively optimize stylized output 820 until the compositional loss function 830 is minimized, or until compositional loss function 830 is below a predetermined threshold.

Transfer engine 122 generates style transfer results 220 based on optimized stylized output 620. Style transfer results 220, as discussed above, include an updated NeRF or other representation of 3D scene 202. As discussed above in the description of FIG. 2, style transfer results 220 include structural elements based on one or more of content samples 200 and stylistic elements based on one or more of style samples 210. For example, a content sample included in content samples 200 may depict multiple objects, and style samples included in style samples 210 may include, e.g., drawings, photographs, paintings, or sketches. Based on the content sample and style samples, transfer engine 122 may generate style transfer results 220 that include structural representations of the objects included in the content sample, with each object modified to include one or more stylistic elements included in a corresponding style sample, such as colors, textures, patterns, and/or lighting characteristics. In various embodiments, the style transfer techniques are informed and guided by 2D masks 440. For example, one or more of 2D masks 440 may designate one or more regions included in content samples 200 to which an artistic style is to be transferred. One or more of 2D masks 440 may designate one or more regions included in content samples 200 to which no artistic style is to be transferred. Style transfer results 220 may be used to render novel 2D views of 3D scene 202 that include structural elements of 3D scene 202 and stylistic elements of one or more style samples 210 applied to specific regions of the 3D scene as defined by 2D masks 440.

FIG. 9 is a flow diagram of method steps for performing style transfer, according to various other embodiments. Although the method steps are described in conjunction with the systems of FIGS. 1-2, 4, and 8, persons skilled in the art will understand that any system configured to perform the method steps in any order falls within the scope of the present disclosure.

As shown, in step 902 of method 900, transfer engine 122 receives features 430 and 2D masks 440. Features 430 may be extracted from one or more content samples 200 and one or more style samples 210. 2D masks 440 represent regions included in one or more content samples 200. Each of the masks included in 2D masks 440 may include a mask label m indicating that the region is to be modified via transfer engine 122 based on stylistic elements included in one of style samples 210 having a label with the same value of m. One or more 2D masks 440 may alternatively include a mask label indicating that the corresponding region(s) are to remain unmodified.

In step 904, transfer engine 122 performs compositional nearest neighbor (NN) feature matching via compositional NN feature matching module 810. In some embodiments, for each region included in one of content samples 200 and having an associated mask label m, compositional NN feature matching module 810 performs pixel-wise nearest neighbor feature matching. For each pixel included in the region, compositional NN feature matching module 810 determines a nearest feature associated with one of style samples 210 having the same label m based on, e.g., a cosine vector distance. For a region that has an associated mask label indicating that the region is to remain unmodified, transfer engine 122 may omit the determination of a nearest feature vector associated with one of style samples 210.

In step 906, transfer engine 122 generates stylized output 820 based on the nearest neighbor feature matching. In some embodiments, stylized output 820 is associated with a pixel-wise arrangement of features that is used with compositional loss function 830 to compute one or more losses. For an unmodified region included in stylized output 820, the features in stylized output 820 include features included in one of content samples 200. For a region included in stylized output 820 associated with one of 2D masks 440 having a mask label value m, the features in the region include features extracted from one of style samples 210 having the same mask label value m.

In step 908, transfer engine 122 optimizes stylized output 820 based on compositional loss function 830. In various embodiments, compositional loss function 830 calculates a different object loss for regions having different values of mask value m. Transfer engine 122 may iteratively modify NeRF 400 or another representation of 3D scene 202 based on compositional loss function 830.

In step 910, transfer engine 122 generates style transfer results 220 based on stylized output 820. For example, transfer engine 122 may generate style transfer results 220 as a representation of 3D scene 202 and/or renderings of 3D scene 202 that are generated after a certain number of optimization steps has been performed, losses computed using compositional loss function 830 fall below a threshold, and/or another condition is met. Style transfer results 220 include structural elements included in one of content samples 200 and stylistic elements included in one or more of style samples 210. For example, style transfer results 220 may include one or more objects depicted in one of content samples 200, where each of the one or more objects is modified based on stylistic elements included in one of style samples 210.

### Semantically Aware Nearest Neighbor Feature Matching

FIG. 10 is a more detailed illustration of preprocessing engine 120 of FIG. 1, according to various other embodiments. FIG. 10 illustrates how preprocessing engine 120 processes content samples 200 and style samples 210 for semantically aware nearest neighbor feature matching as described below in the description of FIG. 12. Preprocessing engine 120 performs both visual and semantic feature extraction on one or more of content samples 200 and one or more of style samples 210. Preprocessing engine 120 may generate features 1050 based on extracted visual and semantic features. Preprocessing engine 120 may perform segmentation on content samples 200 and style samples 210 to generate 2D masks 1060. Preprocessing engine 122 also includes, without limitation, feature extractor 1010, semantic feature extractor 1020, and segmentation module 1040.

Preprocessing engine 120 receives content samples 200 and style samples 210. As discussed above in reference to FIGS. 2 and 4, content samples 200 may include 2D renderings of 3D scene 202 as encoded by NeRF 400 or another representation of 3D scene 202. Style samples may include one or more 2D representations that include one or more stylistic elements, such as patterns, textures, colors, or lighting characteristics.

Feature extractor 1010 generates visual features based on one or more of content samples 200 and one or more of style samples 210. In various embodiments, feature extractor 1010 may include a Visual Geometry Group (VGG) feature extractor, a Convolutional Neural Network (CNN) feature extractor, and/or any other machine learning techniques suitable for generating features in a feature space. For example, for each pixel included in one of content samples 200 or one of style samples 210, feature extractor 1010 may generate a set of visual features in feature space based on visual and/or other attributes associated with the pixel. Feature extractor 1010 transmits the generated visual features to features 1050. In various embodiments, feature extractor 1010 may also transmit the generated visual features directly to transfer engine 122.

Semantic feature extractor 1020 generates features based on one or more of content samples 200 and one or more of style samples 210. In various embodiments, semantic feature extractor 1020 may include a semantically aware feature extraction model, such as LSeg, or any other machine learning technique suitable for extracting features from images based on semantic attributes of the images. In various embodiments, semantic feature extractor 1020 may include a large language model that has been previously trained on a training data set of image-text pairs. Semantic feature extractor 1020 transmits the generated semantic features to features 1050.

Segmentation module 1040 generates one or more 2D masks 1060 associated with one or more content samples 200 and/or one or more style samples 210. Segmentation module 1040 may include a semantically aware segmentation technique, such as LSeg and/or any other segmentation technique suitable for generating 2D masks associated with 2D representations. In various embodiments, segmentation module 1040 may generate masks based on visual characteristics of a 2D representation, such as lines, surfaces, textures, or colors included in the 2D representation. Segmentation module 1040 may also generate masks based on semantic features included in a 2D representation. For example, segmentation module 1040 may identify a specific object included in the 2D representation as a horse and generate a 2D mask 1060 associated with the horse. In yet other embodiments, segmentation module 1040 may additionally or alternatively generate 2D masks 1060 based on user input. For example, a user may manually draw and/or otherwise annotate one or more pixels and/or a region included in one or more of content samples 200 and/or style samples 210, and segmentation module 1040 may generate a 2D mask 1060 based on the annotation. In various embodiments, the disclosed techniques may perform style transfer without the necessity for 2D masks 1060, in which case segmentation module 1040 and/or 2D masks 1060 may be omitted.

Each of 2D masks 1060 is associated with a set of pixels included in one or more of content samples 200 and/or a set of pixels included in one or more of style samples 210. A set of pixels may be contiguous or non-contiguous. Each of 2D masks 1060 may include an assigned class m out of M classes, such that each pixel included in one of 2D masks 1060 is associated with the class m assigned to the one of 2D masks 1060.

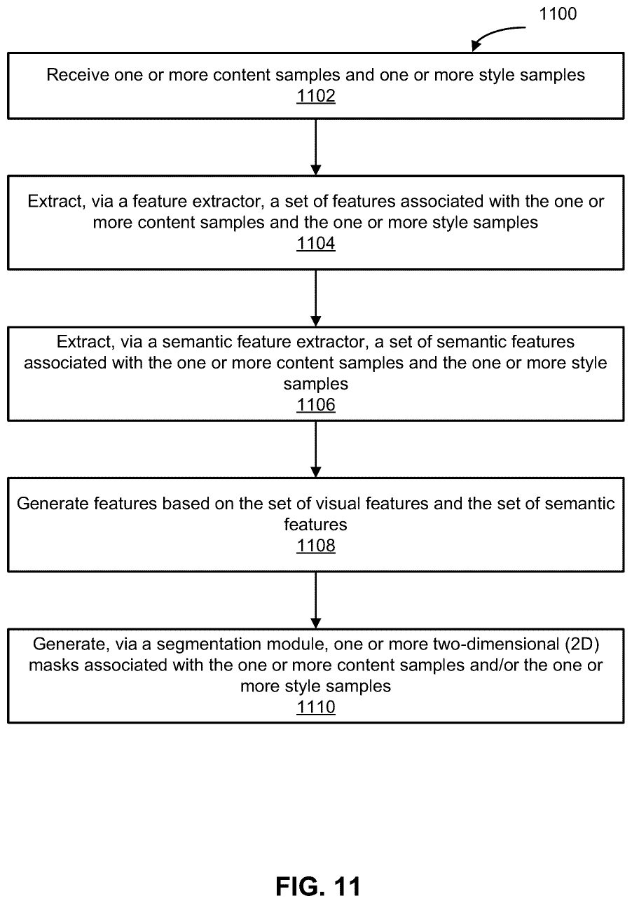

FIG. 11 is a flow diagram of method steps for preprocessing content and style examples, according to various other embodiments. Although the method steps are described in conjunction with the systems of FIGS. 1-2, 4, and 10, persons skilled in the art will understand that any system configured to perform the method steps in any order falls within the scope of the present disclosure.

As shown, in step 1102 of method 1100, preprocessing engine 120 receives content samples 200 and style samples 210. Each of content samples 200 may include a 2D rendering of 3D scene 202 as encoded by NeRF 400 or another representation of 3D scene 202. Each of style samples 210 may include a 2D representation including stylistic elements, such as colors, textures, patterns, or lighting characteristics.

In step 1104, preprocessing engine 122 extracts, via feature extractor 1010, a set of visual features associated with one or more content samples 200. Feature extractor 1010 may also extract a set of visual features associated with one or more style samples 210. Feature extractor 1010 may include a VGG feature extractor and/or a CNN feature extractor.

In step 1106, preprocessing engine 122 extracts, via semantic feature extractor 1020, a set of semantic features associated with one or more of content samples 200. Semantic feature extractor 1020 may also extract a set of semantic features associated with one or more of style samples 210.

In step 1108, preprocessing engine 122 generates features 1050 based on the set of visual features and the set of semantic features. Features 1050 may include one or more visual and/or semantic features associated with one or more of content samples 200 and/or style samples 210.

In step 1110, preprocessing engine 120 generates one or more 2D masks 1060 via segmentation module 1040. Each of 2D masks 1060 identifies a region of pixels included in one of content samples 200 or one of style samples 210. Each of 2D masks 1060 may include an assigned class m out of M classes, such that each pixel included in one of 2D masks 1060 is associated with the class m assigned to the one of 2D masks 1060. In various embodiments, the disclosed techniques may perform style transfer without the necessity for 2D masks 1060, in which case segmentation module 1040 and/or 2D masks 1060 may be omitted.

FIG. 12 is a more detailed illustration of transfer engine 122 of FIG. 1, according to various other embodiments. FIG. 12 illustrates how transfer engine 122 performs semantically aware nearest neighbor feature matching. Transfer engine 122 receives features 1050 and visual features 1240 from preprocessing engine 120. In various embodiments, transfer engine 122 may also receive content masks 1230 and/or style masks 1220. Transfer engine 122 performs semantic nearest neighbor feature matching to transfer style elements from one or more regions included in a style sample to one or more regions included in a content sample based on features 1050 and/or content masks 1230 and style masks 1220. Transfer engine 122 generates style transfer results 220 based on the feature matching. Transfer engine 122 includes, without limitation, semantic NN feature matching module 1210, optimizer 1250, and visual loss function 1260.

As discussed above in the description of FIG. 10, features 1050 include visual and/or semantic features generated by feature extractor 1010 and semantic feature extractor 1020 of preprocessing engine 120. Each of the visual and/or semantic features may be associated with a pixel location included in one of content samples 200 or style samples 210.

Content masks 1230 include one or more 2D masks, where each mask is associated with a region of pixels included in one or more of content samples 200. Each 2D mask may include an associated label m. In various embodiments, content masks 1230 may be omitted, as semantic nearest neighbor (NN) feature matching module 1210 as discussed below is operable to perform feature matching based solely on features 1050.

Style masks 1220 include one or more 2D masks, where each mask is associated with a region of pixels included in one or more of style samples 210. Each 2D mask may include an associated label m. In various embodiments, style masks 1220 may be omitted, as semantic nearest neighbor (NN) feature matching module 1210 is operable to perform feature matching based solely on features 1050.

Semantic NN feature matching module 1210 performs nearest neighbor matching between features 1050 associated with one of content samples 200 and one of style samples 210. Semantic NN feature matching module 1210 determines a nearest neighbor for a pixel location (x, y) having a label m:

$$SNNFM ( x , y , m ) = arg {min}_{{x}^{′} , {y}^{′} ∈ S} {D}_{snnfm} \qquad ( 11 )$$

$$where$$

$$S = \{ {x}^{′} , {y}^{′} \vert {M}_{s} ( {x}^{′} , {y}^{′} ) = m \} \qquad ( 12 )$$

$$and$$

$${D}_{snnfm} = α \cdot D ( {F}_{r}^{Vis} ( x , y ) , {F}_{s}^{Vis} ( {x}^{′} , {y}^{′} ) ) + ( 1 - α ) \cdot D ( {F}_{r}^{Sem} ( x , y ) , {F}_{s}^{Sem} ( {x}^{′} , {y}^{′} ) ) \qquad ( 13 )$$

Equation (11) determines a pixel location (x′, y′) in one of style samples 210 with features that minimize the distance from features for pixel location (x, y) included in one of content samples 200. Equation (12) limits the scope of possible pixel locations (x′, y′) to locations included in S.

Equation (12) defines S as the set of pixel locations (x′, y′) associated with one of style samples 210 for which a mask Mₛ associated with the pixel location has the same label m as the (x, y) pixel location evaluated in Equation (11). In other words, for a given set of features associated with a pixel location in one of content samples 200, semantic NN feature matching module 1210 calculates distances between the set of features and additional features that are associated with one of style samples 210 and have the same label m as the pixel location.

Transfer engine 122 calculates the vector distance D_{snnfm} given in Equation (13) based on a blended combination of a distance between pixel locations in a content sample 200 and a style sample 210 in visual vector space, and a distance between pixel locations in a content sample 200 and a style sample 210 in semantic vector space. Transfer engine 122 receives extracted visual features from feature extractor 1010 and extracted semantic features from semantic feature extractor 1020. Transfer engine 122 includes an adjustable hyperparameter α∈[0,1]. As shown in Equation (13), transfer engine 122 calculates the vector distance D_{snnfm} by multiplying a vector distance D in visual feature space by hyperparameter α, multiplying a vector distance D in semantic feature space by (1−α), and summing the products. By adjusting the value of hyperparameter α, transfer engine 122 may adjust the relative contributions of feature distances in visual space and feature distances in semantic space. For example, a value of α=1 will determine D_{snnfm} in Equation (13) based solely on a vector distance D in visual feature space, while a value of α=0 will determine D_{snnfm} based solely on a vector distance D in semantic feature space.

In various embodiments, semantic NN feature matching module 1210 receives content masks 1230 and/or style masks 1220. Each of content masks 1230 and style masks 1220 includes one or more 2D masks, where each 2D mask represents a region included in one of content samples 200 or one of style samples 210. Each 2D mask may include a ground-truth label associated with the 2D mask. Semantic NN feature matching module 1210 may analyze the regions and/or labels included in one or both of content masks 1230 or style masks 1220 to further inform the semantic nearest neighbor feature matching.

Semantic NN feature matching module 1210 records, for each pixel location associated with one of content samples 200, a nearest feature associated with one of style samples 210, where the nearest feature includes the same label m as a feature associated with the pixel location included in the one of content samples 200. As discussed above, transfer engine 122 determines the nearest feature based on Equations 12-14. For a pixel location in the one of content samples 200 that does not include an associated label or that includes a label indicating that the pixel location is to remain unmodified, semantic NN feature matching module 1210 may record the features associated with the pixel location included in the one of content samples 200, rather than recording a nearest feature associated with one of style samples 210. Semantic NN feature matching module 1210 transmits the recorded features for each pixel location to optimizer 1250.

Optimizer 1250 optimizes NeRF 400 or another representation of 3D scene 202 based on features recorded by semantic NN feature matching module 1210, visual features 1240 generated by feature extractor 1010, and visual loss function 1260. Visual loss function 1260 calculates a semantic nearest neighbor feature matching loss l_{snnfm}:

$${l}_{snnfm} = \frac{1}{N} {\sum }_{x , y} D ( {F}_{r}^{Vis} ( x , y ) , {F}_{s}^{Vis} ( SNFFM ( x , y , m ) ) ) \qquad ( 14 )$$

where N is the number of pixels, D is the vector distance calculation given by Equation (9) above, SNFFM(x,y,m) is given by Equation (12) above, and Fᵣ^{Vis} and Fₛ^{Vis} represent visual features associated with one of content samples 200 and one of style samples 210, respectively.

In some embodiments, optimizer 1250 may iteratively modify one or more parameters of NeRF 400 or another representation of 3D scene 202 until the semantic nearest neighbor feature matching loss l_{snnfm} is below a predetermined threshold. In other embodiments, optimizer 1250 may modify the one or more parameters for a predetermined number of iterations, or for a predetermined period of time.

Transfer engine 122 generates style transfer results 220 based on the output of optimizer 1250. Style transfer results 220 may include NeRF 400 or another representation of 3D scene 202, modified as discussed above with stylistic elements included in one of style samples 210, such as colors, textures, patterns, and/or lighting characteristics. Style transfer results 220 may be used to generate novel views of 3D scene 202 in which objects or other structural elements included in 3D scene 202 are modified to include stylistic elements included in one or more of style samples 210.

FIG. 13 is a flow diagram of method steps for performing style transfer, according to various other embodiments. Although the method steps are described in conjunction with the systems of FIGS. 1-2, 10, and 12, persons skilled in the art will understand that any system configured to perform the method steps in any order falls within the scope of the present disclosure.

As shown, in step 1302 of method 1300, transfer engine 122 receives features 1050 and optional content masks 1230 and/or style masks 1220. Features 1050 include visual and/or semantic features associated with pixel locations included in one or more of content samples 200 and one or more of style samples 210. Each of features 1050 may include an associated label m.

Content masks 1230 include one or more 2D masks, where each 2D mask is associated with a region of pixels included in one of content samples 200. Each of content masks 1230 may include an associated label m. Style masks 1220 include one or more 2D masks, where each 2D mask is associated with a region of pixels included in one of style samples 210. Each of style masks 1220 may include an associated label m. In various embodiments, transfer engine 122 analyzes content masks 1230 and/or style masks 1220 to inform the operation of semantic NN feature matching module 1210. In various other embodiments, content masks 1230 and/or style masks 1220 may be omitted, as transfer engine 122 is operable to perform semantic feature matching based solely on features 1050.

In step 1304, transfer engine 122 performs semantic nearest neighbor feature matching via semantic NN feature matching module 1210, based on at least features 1050. For each of features 1050 associated with one of content samples 200 and located at a pixel location (x, y), semantic NN feature matching module 1210 determines a nearest one of features 1050 associated with one of style samples 210 and having a same label m as the feature associated with one of content samples 200. For each pixel location (x, y), semantic NN feature matching module 1210 records the nearest one of features 1050 associated with one of style samples 210. If a pixel location (x, y) associated with one of content samples 200 does not have an associated label m, or has a label m indicating that features associated with pixel location (x, y) are not to be modified, semantic NN feature matching module 1210 instead records the feature associated with the one of content samples 200.

In step 1306, transfer engine 122 optimizes NeRF 400 or another representation of 3D scene 202 based on visual features 1240 and visual loss function 1260. Transfer engine 122 iteratively modifies one or more parameters included in NeRF 400 or another representation of 3D scene 202 based on features recorded by semantic NN feature matching module 1210 and visual loss function 1260. Transfer engine 122 may continue to iteratively modify the one or more parameters for a predetermined number of iterations or for a predetermined period of time. In various embodiments, transfer engine 122 may iteratively modify the one or more parameters until visual loss function 1260 is below a predetermined threshold.

In step 1308, transfer engine 122 generates style transfer results 220 based on the optimized features. Style transfer results 220 may include a modified NeRF or other representation of 3D scene 202 in which one or more objects or other structural elements included in 3D scene 202 are modified with stylistic elements included in one or more of style samples 210.

In sum, the disclosed techniques perform style transfer based on one or more content samples and one or more style samples. The one or more content samples may include rendered views of a 3D scene that has been encoded by, e.g., a neural radiance field (NeRF) or other representation of the 3D scene. The disclosed techniques generate one or more modified representations of the 3D scene that include structural elements included in the content sample(s), such as people or objects, and stylistic elements included in the style examples, such as colors, textures, patterns, or light characteristics. The disclosed techniques include selection of one or more specific regions within a content sample and may perform style transfer on portions of the representation associated with the selected region(s) while leaving other portions of the representation unmodified. The disclosed techniques may also transfer different styles to different portions of the representation.

A preprocessing engine includes a segmentation module that divides an input content sample into one or more labeled regions. A labeled region may indicate a portion of the content sample, e.g., a person or an object, to which a style is to be transferred, while a different labeled region may indicate a different portion of the content sample to which a different style is to be transferred. Alternatively, a labeled region may indicate a portion of the content sample that will not be modified with a style. Each labeled region in the content sample is associated with a 2D mask representing the region. Each labeled region may include a textual label, where the textual label may be provided by a user or may be automatically generated by the segmentation module. The preprocessing engine may perform segmentation on each of the content samples, where each content sample includes a different viewpoint of a 3D scene as encoded by, e.g., a neural radiance field (NeRF). The segmentation module may also divide a style sample into multiple labeled regions.

The preprocessing engine also includes a semantic feature extractor and/or a visual feature extractor. Each of the semantic feature extractor and the visual feature extractor may analyze both a content sample and a style sample and generate features for individual pixels and/or regions of pixels included in the content sample and the style sample.

A transfer engine includes a nearest neighbor feature matching module that determines a nearest neighbor feature included in a style sample for each feature included in a content sample, based on the generated features and/or 2D masks associated with the content sample and style sample. The transfer engine generates a modified representation of the 3D scene, e.g., a modified NeRF, based on the nearest neighbor feature matching and optimizes the modified representation based on one or more loss functions. The transfer engine generates style transfer results including the modified representation, where the modified representation includes structural elements based on the content sample(s) and stylistic elements based on the style sample(s).

One technical advantage of the disclosed techniques relative to the prior art is that the disclosed techniques allow for fine-grained controllability of style transfer to a 3D scene based on masks that identify specific regions of 2D renderings of the 3D scene. The disclosed techniques also allow for the transfer of different styles to different regions of a 3D scene. Further, the disclosed techniques include semantically aware style transfer via masks based on semantic features included in content and/or style samples. These technical advantages provide one or more technological improvements over prior art approaches.

1. In some embodiments, a computer-implemented method for performing style transfer comprises converting a style sample into a first set of semantic features and a first set of visual features, determining a set of content samples corresponding to a plurality of views of a three-dimensional (3D) scene, for each content sample included in the set of content samples converting the content sample into an additional set of semantic features and an additional set of visual features, and determining a set of matches between (i) the additional set of semantic features and the additional set of visual features and (ii) the first set of semantic features and the first set of visual features, and generating a style transfer result that includes a representation of the 3D scene based on one or more losses associated with the sets of matches determined for the set of content samples, wherein the style transfer result comprises one or more structural elements of the 3D scene and one or more stylistic elements of the style sample.

2. The computer-implemented method of clause 1, wherein determining the set of matches comprises computing a distance based on (i) a subset of the additional set of semantic features associated with a portion of the content sample, (ii) a subset of the additional set of visual features associated with the portion of the content sample, (iii) a subset of the first set of semantic features associated with a portion of the style sample, and (iv) a subset of the first set of visual features associated with the portion of the style sample.

3. The computer-implemented method of clauses 1 or 2, wherein the distance comprises a weighted combination of (i) a first distance between the subset of the additional set of semantic features and the subset of the first set of semantic features and (ii) a second distance between the subset of the additional set of visual features and the subset of the first set of visual features.

4. The computer-implemented method of any of clauses 1-3, wherein the style sample includes a 2D depiction of one or more of a painting, a sketch, a drawing, or a photograph.

5. The computer-implemented method of any of clauses 1-4, wherein the one or more structural elements include one or more of objects, lines, surfaces, or backgrounds, and the one or more stylistic elements include one or more of patterns, colors, textures, or lighting characteristics.

6. The computer-implemented method of any of clauses 1-5, wherein generating the style transfer result comprises computing the one or more losses based on a set of distances associated with visual features included in the sets of matches determined for the set of content samples, and iteratively modifying the representation of the 3D scene based on the one or more losses.

7. The computer-implemented method of any of clauses 1-6, wherein determining the set of matches comprises determining a set of two-dimensional (2D) masks associated with the set of content samples and an additional 2D mask associated with the style sample, and determining the sets of matches between (i) a subset of the additional set of semantic features and the additional set of visual features associated with the set of 2D masks and (ii) a subset of the first set of semantic features and the first set of visual features associated with the 2D mask.

8. The computer-implemented method of any of clauses 1-7, wherein determining the set of 2D masks and the additional 2D mask comprises matching the set of 2D masks to the additional 2D mask based on a label associated with the set of 2D masks and the additional 2D mask.

9. The computer-implemented method of any of clauses 1-8, wherein each content sample included in the set of content samples includes a two-dimensional (2D) rendering of the 3D scene.

10. The computer-implemented method of any of clauses 1-9, wherein the representation of the 3D scene comprises a neural radiance field (NeRF).

11. In some embodiments, one or more non-transitory computer-readable media store instructions that, when executed by one or more processors, cause the one or more processors to perform the steps of converting a style sample into a first set of semantic features and a first set of visual features, determining a set of content samples corresponding to a plurality of views of a three-dimensional (3D) scene, for each content sample included in the set of content samples converting the content sample into an additional set of semantic features and an additional set of visual features, and determining a set of matches between (i) the additional set of semantic features and the additional set of visual features and (ii) the first set of semantic features and the first set of visual features, and generating a style transfer result that includes a representation of the 3D scene based on one or more losses associated with the sets of matches determined for the set of content samples, wherein the style transfer result comprises one or more structural elements of the 3D scene and one or more stylistic elements of the style sample.

12. The one or more non-transitory computer-readable media of clause 11, wherein determining the set of matches comprises computing a distance based on (i) a subset of the additional set of semantic features associated with a portion of the content sample, (ii) a subset of the additional set of visual features associated with the portion of the content sample, (iii) a subset of the first set of semantic features associated with a portion of the style sample, and (iv) a subset of the first set of visual features associated with the portion of the style sample.

13. The one or more non-transitory computer-readable media of clauses 11 or 12, wherein the distance comprises a weighted combination of (i) a first distance between the subset of the additional set of semantic features and the subset of the first set of semantic features and (ii) a second distance between the subset of the additional set of visual features and the subset of the first set of visual features.

14. The one or more non-transitory computer-readable media of any of clauses 11-13, wherein generating the style transfer result comprises the steps of computing the one or more losses based on a set of distances associated with visual features included in the sets of matches determined for the set of content samples, and iteratively modifying the representation of the 3D scene based on the one or more losses.

15. The one or more non-transitory computer-readable media of any of clauses 11-14, wherein determining the set of matches comprises the steps of determining a set of two-dimensional (2D) masks associated with the set of content samples and an additional 2D mask associated with the style sample, and determining the sets of matches between (i) a subset of the additional set of semantic features and the additional set of visual features associated with the set of 2D masks and (ii) a subset of the first set of semantic features and the first set of visual features associated with the 2D mask.

16. The one or more non-transitory computer-readable media of any of clauses 11-15, wherein determining the set of 2D masks and the additional 2D mask comprises the step of matching the set of 2D masks to the additional 2D mask based on a label associated with the set of 2D masks and the additional 2D mask.

17. The one or more non-transitory computer-readable media of any of clauses 11-16, wherein each content sample included in the set of content samples includes a two-dimensional (2D) rendering of the 3D scene.

18. In some embodiments, a system comprises one or more memories storing instructions, and one or more processors for executing the instructions to convert a style sample into a first set of semantic features and a first set of visual features, determine a set of content samples corresponding to a plurality of views of a three-dimensional (3D) scene, for each content sample included in the set of content samples convert the content sample into an additional set of semantic features and an additional set of visual features, and determine a set of matches between (i) the additional set of semantic features and the additional set of visual features and (ii) the first set of semantic features and the first set of visual features, and generate a style transfer result that includes a representation of the 3D scene based on one or more losses associated with the sets of matches determined for the set of content samples, wherein the style transfer result comprises one or more structural elements of the 3D scene and one or more stylistic elements of the style sample.

19. The system of clause 18, wherein the instructions to determine the set of matches comprise instructions to compute a distance based on (i) a subset of the additional set of semantic features associated with a portion of the content sample, (ii) a subset of the additional set of visual features associated with the portion of the content sample, (iii) a subset of the first set of semantic features associated with a portion of the style sample, and (iv) a subset of the first set of visual features associated with the portion of the style sample.

20. The system of clauses 18 or 19, wherein the distance comprises a weighted combination of (i) a first distance between the subset of the additional set of semantic features and the subset of the first set of semantic features and (ii) a second distance between the subset of the additional set of visual features and the subset of the first set of visual features.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing style transfer, the method comprising:
converting a style sample into a first set of semantic features and a first set of visual features;
determining a set of content samples corresponding to a plurality of views of a three-dimensional (3D) scene;
for each content sample included in the set of content samples:
converting the content sample into an additional set of semantic features and an additional set of visual features; and
determining a set of matches between (i) the additional set of semantic features and the additional set of visual features and (ii) the first set of semantic features and the first set of visual features; and
generating a style transfer result that includes a representation of the 3D scene based on one or more losses associated with the sets of matches determined for the set of content samples, wherein the style transfer result comprises one or more structural elements of the 3D scene and one or more stylistic elements of the style sample.

2. The computer-implemented method of claim 1, wherein determining the set of matches comprises computing a distance based on (i) a subset of the additional set of semantic features associated with a portion of the content sample, (ii) a subset of the additional set of visual features associated with the portion of the content sample, (iii) a subset of the first set of semantic features associated with a portion of the style sample, and (iv) a subset of the first set of visual features associated with the portion of the style sample.

3. The computer-implemented method of claim 2, wherein the distance comprises a weighted combination of (i) a first distance between the subset of the additional set of semantic features and the subset of the first set of semantic features and (ii) a second distance between the subset of the additional set of visual features and the subset of the first set of visual features.

4. The computer-implemented method of claim 1, wherein the style sample includes a 2D depiction of one or more of a painting, a sketch, a drawing, or a photograph.

5. The computer-implemented method of claim 1, wherein the one or more structural elements include one or more of objects, lines, surfaces, or backgrounds, and the one or more stylistic elements include one or more of patterns, colors, textures, or lighting characteristics.

6. The computer-implemented method of claim 1, wherein generating the style transfer result comprises:
computing the one or more losses based on a set of distances associated with visual features included in the sets of matches determined for the set of content samples; and
iteratively modifying the representation of the 3D scene based on the one or more losses.

7. The computer-implemented method of claim 1, wherein determining the set of matches comprises:
determining a set of two-dimensional (2D) masks associated with the set of content samples and an additional 2D mask associated with the style sample; and
determining the sets of matches between (i) a subset of the additional set of semantic features and the additional set of visual features associated with the set of 2D masks and (ii) a subset of the first set of semantic features and the first set of visual features associated with the 2D mask.

8. The computer-implemented method of claim 7, wherein determining the set of 2D masks and the additional 2D mask comprises matching the set of 2D masks to the additional 2D mask based on a label associated with the set of 2D masks and the additional 2D mask.

9. The computer-implemented method of claim 1, wherein each content sample included in the set of content samples includes a two-dimensional (2D) rendering of the 3D scene.

10. The computer-implemented method of claim 1, wherein the representation of the 3D scene comprises a neural radiance field (NeRF).

11. One or more non-transitory computer-readable media storing instructions that, when executed by one or more processors, cause the one or more processors to perform the steps of:
converting a style sample into a first set of semantic features and a first set of visual features;
determining a set of content samples corresponding to a plurality of views of a three-dimensional (3D) scene;
for each content sample included in the set of content samples:
converting the content sample into an additional set of semantic features and an additional set of visual features; and
determining a set of matches between (i) the additional set of semantic features and the additional set of visual features and (ii) the first set of semantic features and the first set of visual features; and
generating a style transfer result that includes a representation of the 3D scene based on one or more losses associated with the sets of matches determined for the set of content samples, wherein the style transfer result comprises one or more structural elements of the 3D scene and one or more stylistic elements of the style sample.

12. The one or more non-transitory computer-readable media of claim 11, wherein determining the set of matches comprises computing a distance based on (i) a subset of the additional set of semantic features associated with a portion of the content sample, (ii) a subset of the additional set of visual features associated with the portion of the content sample, (iii) a subset of the first set of semantic features associated with a portion of the style sample, and (iv) a subset of the first set of visual features associated with the portion of the style sample.

13. The one or more non-transitory computer-readable media of claim 12, wherein the distance comprises a weighted combination of (i) a first distance between the subset of the additional set of semantic features and the subset of the first set of semantic features and (ii) a second distance between the subset of the additional set of visual features and the subset of the first set of visual features.

14. The one or more non-transitory computer-readable media of claim 11, wherein generating the style transfer result comprises the steps of:
computing the one or more losses based on a set of distances associated with visual features included in the sets of matches determined for the set of content samples; and
iteratively modifying the representation of the 3D scene based on the one or more losses.

15. The one or more non-transitory computer-readable media of claim 11, wherein determining the set of matches comprises the steps of:
determining a set of two-dimensional (2D) masks associated with the set of content samples and an additional 2D mask associated with the style sample; and
determining the sets of matches between (i) a subset of the additional set of semantic features and the additional set of visual features associated with the set of 2D masks and (ii) a subset of the first set of semantic features and the first set of visual features associated with the 2D mask.

16. The one or more non-transitory computer-readable media of claim 15, wherein determining the set of 2D masks and the additional 2D mask comprises the step of matching the set of 2D masks to the additional 2D mask based on a label associated with the set of 2D masks and the additional 2D mask.

17. The one or more non-transitory computer-readable media of claim 11, wherein each content sample included in the set of content samples includes a two-dimensional (2D) rendering of the 3D scene.

18. A system comprising:
one or more memories storing instructions; and
one or more processors for executing the instructions to:
convert a style sample into a first set of semantic features and a first set of visual features;
determine a set of content samples corresponding to a plurality of views of a three-dimensional (3D) scene;
for each content sample included in the set of content samples:
convert the content sample into an additional set of semantic features and an additional set of visual features; and
determine a set of matches between (i) the additional set of semantic features and the additional set of visual features and (ii) the first set of semantic features and the first set of visual features; and
generate a style transfer result that includes a representation of the 3D scene based on one or more losses associated with the sets of matches determined for the set of content samples, wherein the style transfer result comprises one or more structural elements of the 3D scene and one or more stylistic elements of the style sample.

19. The system of claim 18, wherein the instructions to determine the set of matches comprise instructions to compute a distance based on (i) a subset of the additional set of semantic features associated with a portion of the content sample, (ii) a subset of the additional set of visual features associated with the portion of the content sample, (iii) a subset of the first set of semantic features associated with a portion of the style sample, and (iv) a subset of the first set of visual features associated with the portion of the style sample.

20. The system of claim 19, wherein the distance comprises a weighted combination of (i) a first distance between the subset of the additional set of semantic features and the subset of the first set of semantic features and (ii) a second distance between the subset of the additional set of visual features and the subset of the first set of visual features.
